(19) United States
(12) Patent Application Publication
(10) Pub. No.: US 2009/0182644 A1
(43) Pub. Date: Jul. 16, 2009

(54) SYSTEMS AND METHODS FOR CONTENT TAGGING, CONTENT VIEWING AND ASSOCIATED TRANSACTIONS

(76) Inventors: Nicholas Panagopulos, Brooklyn, NY (US); William E. Davidson, IV, Montgomery Village, MD (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/355,297

(22) Filed: Jan. 16, 2009

Related U.S. Application Data
(60) Provisional application No. 61/021,562, filed on Jan. 16, 2008.

(51) Int. Cl. G06Q 30/00; G06F 3/048; G06F 17/30; G06F 15/16

(52) U.S. Cl. 705/26; 715/716; 707/1; 709/231; 707/E17.001

(57) ABSTRACT

In some embodiments, a method includes initiating a tagging event associated with an item included in a media content. The initiating is based on the actuation of an indicia in a video module. Data associated with the item from the media content is input into the video module. The video module is configured to display at least one candidate item related to the item from the media content based on item data from a third-party. After a candidate item is selected, the item from the media content is tagged such that the candidate item is associated with the item from the media content.

### RELATED APPLICATION

This application claims priority to U.S. Provisional Patent Application No. 61/021,562, entitled “Systems and Methods for Content Tagging, Content Viewing and Associated Transactions,” filed on Jan. 16, 2008, which is incorporated herein by reference in its entirety.

### BACKGROUND

The embodiments described herein relate generally to systems and methods for tagging video content, viewing tagged content and performing an associated transaction.

Many consumers' purchases in today's electronic commerce (e-commerce) market place are driven by advertising they have viewed or casual viewing of a particular product. For example, consumers are often motivated to purchase some content (e.g., a particular product, a particular song or album, a trip to particular location) based on having seen it in a movie, a television show, a video clip, etc.

Known systems of tagging video content allow consumers to purchase content they view in a media program. Such known systems of tagging video content, however, are labor intensive and expensive. For example, some known systems require a user (i.e., an employee) to tag content in a media program by identifying the shape of the content. Additionally, in some known systems the user has to find and link a comparable product to the tagged content in the media program. The corresponding time and cost for an employee to tag content in a single video can be excessive.

Further, known systems of tagging video content make identifying a tagged video content difficult for the consumer. For example, some known systems do not provide an indication to the consumer that content in the media program is available for purchase. Rather, such known systems require the consumer to search the media program for the tagged content. As a result, the consumer can miss the tagged content or be unable to find the tagged content in the media program.

Thus, there is a need for a system and method that allows consumers to easily identify and purchase content they view in a video program. There is also a need for an inexpensive and less labor intensive system and method to identify and tag the content that is available for potential future purchase.

### SUMMARY

Systems and methods for tagging video content, viewing tagged content and performing an associated transaction are described herein. In some embodiments, a method includes initiating a tagging event associated with an item included in a media content. The initiating is based on the actuation of an indicia in a video module. Data associated with the item from the media content is input into the video module. The video module is configured to display at least one candidate item related to the item from the media content based on item data from a third-party. After a candidate item is selected, the item from the media content is tagged such that the candidate item is associated with the item from the media content.

### BRIEF DESCRIPTION OF THE DRAWINGS

FIG. 1 is a schematic illustration of a system according to an embodiment.

FIGS. 2-4 are schematic illustrations of a back-end and a third-party system according to an embodiment.

FIGS. 5-6 are schematic illustrations of a front-end system according to an embodiment.

FIGS. 7-10 are examples of screen shots of a tagging platform according to an embodiment.

FIGS. 11-15 are illustrations of a tagging platform according to an embodiment.

FIG. 16 is an example of a screen shot of a tagging platform according to an embodiment.

FIGS. 17 and 18 are examples of a front end system according to an embodiment.

FIG. 19 is a flow chart of a method according to an embodiment.

FIG. 20 is a flow chart of a method according to an embodiment.

FIG. 21 is a flow chart of a method according to an embodiment.

FIG. 22 is a flow chart of a method according to an embodiment.

### DETAILED DESCRIPTION

In some embodiments, a method includes initiating a tagging event associated with an item included in a media content. The initiating is based on the actuation of an indicia in a video module (i.e., tagging module). Data associated with the item from the media content, such as, for example, a description of the item from the media content, is input into the video module. The video module is configured to display at least one candidate item related to the item from the media content based on item data from a third-party. After a candidate item is selected, the item from the media content is tagged such that the candidate item is associated with the item from the media content. In some embodiments, the method further includes, after the tagging, storing the item data associated with the candidate item that was obtained by the third-party.

In some embodiments, a method includes receiving an initiation signal based on an actuation of an indicia in a video module. The initiation signal initiates a tagging event associated with an item included in a media content. Data from a third-party is obtained based on input associated with the item from the media content, such as, for example, a description of the item from the media content. At least one candidate item related to the item from the media content is displayed in the video module based on the data from the third-party. The item from the media content is associated with a particular candidate item based on a selection of that candidate item. Said another way, the item from the media content is associated with a selected candidate item. In some embodiments, once the item from the media content is associated, each instance of the item from the media content that is included in the media content can be recorded or stored.

In other embodiments, a method includes displaying an indicia in association with a video module. The indicia is associated with at least one tagged item that is included in a portion of a media content in the video module. Data related to each tagged item is retrieved based on the actuation of the indicia. The data, which can be retrieved, for example, by downloading the data from a database, includes a candidate item associated with each tagged item. Each candidate item associated with each tagged item for the portion of the media content in the video module is displayed. The data related to a candidate item is stored when that candidate item is selected in the video module. In some embodiments, the stored data (i.e., the data related to the selected candidate items) can be sent to a third-party such that the candidate items can be purchased, for example, by a consumer, from the third-party.

In yet other embodiments, a method includes receiving a request for data from a third-party. The request includes data associated with an item from a media content, such as, for example, a description of the item from the media content. The requested data, which includes at least one candidate item related to the item from the media content, is sent to the third-party. The third-party is configured to associate the at least one candidate item with the item from the media content such that the third-party stores the data related to the at least one candidate item. A purchase order based on the candidate item associated with the item from the media content is received.

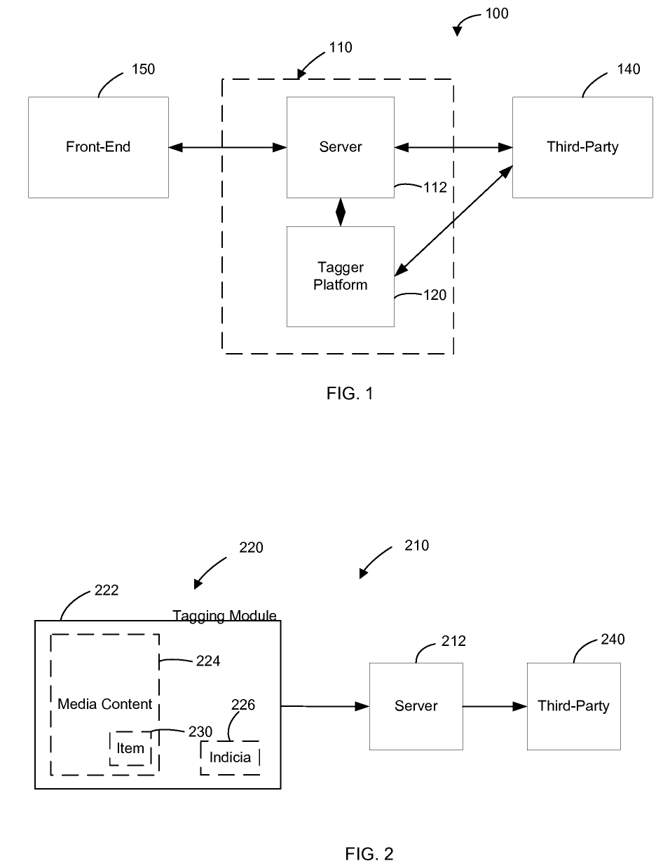

FIG. 1 is a schematic illustration of a system 100 according to an embodiment. The system 100 includes a front-end 150 and a back-end 110, and is associated with a third-party 140. The back-end 110 of the system 100 includes a server 112 and a tagger platform 120. The tagger platform 120 is configured to communicate with the server 112 and the third-party 140. The third-party 140 is configured to communicate with the server 112. Additionally, the front-end 150 is configured to communicate with the back-end 110 of the system 100 via the server 112.

In use, the server 112 is configured to transmit data, such as media content, to the tagger platform 120 and receive input from the tagger platform 120. In some embodiments, the media content can include video content, audio content, still frames, and/or the like. The tagger platform 120 is configured to display the media content on a media viewing device or a graphical user interface (GUI), such as a computer monitor. This allows the user to be able to view the media content and interact with the tagger platform 120. For example, the media content can be a video content with several viewable items such as food items, clothing items, furniture items and/or the like.

The tagger platform 120 is configured to facilitate the tagging of items in the media content. Tagging is the act of associating an item from the media content with a substantially similar item available for viewing, experiencing, or purchasing. For example, a consumer watching a web-program on a particular network may wish to purchase a product (e.g., an item), such as a cooking pan, used in the program. If the desired cooking pan were tagged in the media content, the consumer would be able to obtain more information on the pan including, for example, specifications and/or purchase information. In some embodiments, the tagged item can directly result in the purchase of the product, as will be described in more detail herein. The consumer's interaction with the tagged item occurs at the front-end of the system.

Before the consumer can view information about an item from the media content, the item may have been previously tagged. In some embodiments, the tagger platform 120 and/or server 112 can automatically tag items in the media content based on pre-defined rules. In some embodiments, a user on the back-end can manually tag items in the media content on the tagger platform 120. For example, the tagger platform 120 can be configured to display the media content on a GUI and the user can manually tag items displayed in the media content. Manual tagging can include identifying a particular item (e.g., via a computer mouse) and supplying information to the tagger platform 120 about the item. Such information can include a description of the item or other identifying specifications or characteristics.

The tagger platform 120 transmits this information to a third-party 140. The third-party 140 can be, for example, an e-commerce retail store such as Amazon®. Using the item-identifying information supplied by the user, the third-party 140 can search its inventory for similar products. The third-party 140 can transmit the retail product data that matches the provided criteria from the user. In some embodiments, the third-party 140 can include more than one retail store. In some embodiments, the tagger platform 120 transmits the information to the third-party 140 via the server 112. In some embodiments, however, the tagger platform 120 transmits the information directly to the third-party 140.

The tagger platform 120 makes the retrieved data available to the user. In some embodiments, the retrieved data is displayed as text describing the retail item. In some embodiments, the data is displayed as thumbnail images of the retail items. Based on the supplied data, the user can choose which retail item to associate with the item from the media content. Said another way, the third-party 140 store or sites provide a candidate item or items for selection by the user that most closely or exactly resemble the item in the media content. The user then selects the appropriate candidate item to be associated with the item in the media content. The data associated with the selected candidate item is then stored (e.g., in server 112). The data associated with the selected candidate item can include, for example, detailed product specifications or simply a URL that points to a product description available on the third-party site. In this manner, the item from the media content is tagged. In some embodiments, the tagger platform 120 can be configured to package the media content such that the data related to the retail item is embedded in the media content's metadata stream and associated with the item. In some embodiments, the server is configured to perform such packaging.

The server 112 is configured to transmit the tagged media content to the front-end 150 of the system 100. As previously discussed, the front-end 150 of the system 100 is configured to display the tagged media content on a user interface. In this manner, a consumer viewing the tagged media content on the front-end 150 can attain information on a particular tagged item in the media content, as described above.

In some embodiments, the candidate item (i.e., the retail item) associated with the item in the media content can be purchased. In some such embodiments, the data related to the retail item chosen to be purchased by the customer can be transmitted to the third party 140 such that it can be purchased from the third-party 140. In other embodiments, the retail item associated with the item from the media content can be placed in a “shopping cart” so that the retail item can be purchased at a later time.

In some embodiments, the server 112 can include a ColdFusion/SQL server application such that the data exchanged between the server 112, the front-end 150, and/or the tagger platform 120 is performed by, for example, XML/delimited lists mixed with JSON or JSON alone. In some embodiments, the front-end 150 can include at least one SWF file and/or related Object/Embed code for browsers.

FIGS. 2-4 are schematic illustrations of a back-end 210 and a third-party 240 according to an embodiment. The third-party 240 is configured to communicate with the back-end system 210 via a server 212 of the back-end system 210. The third-party 240 can be, for example, an e-commerce retail store such as Amazon®, with a large inventory of retail products. In some embodiments, the third-party 240 can include more than one e-commerce retail store.

The back-end system 210 includes the server 212 and a tagging platform 220. The tagging platform 220 is a computing platform that is configured to communicate with the server 212. The tagging platform 220 includes a tagging module 222. The tagging platform 220 can be configured to operate on, for example, a personal computer, television, PDA, or any other media viewing device or set of devices that are capable of presenting media. For example, in some embodiments, the tagging platform 220 operates on a personal computer such that the tagging module 222 is displayed on the computer screen of the personal computer. The tagging platform 220 is configured to facilitate the display of the tagging module 222 on a device capable of presenting media.

The tagging module 222 is configured to display a media content 224 and an indicia 226. The indicia 226 is configured to initiate a tagging event when the indicia 226 is actuated. In some embodiments, the tagging module 222 is a media player configured to display the media content 224. For example, in some embodiments, the tagging module 222 can be one of a Flash, Flex, Flash/HTML/AJAX hybrid or the like. In some embodiments, the media content 224 can be a video content, an audio content, still frames or any suitable content capable of being displayed or presented in the tagging module 222.

The media content 224 displayed on the tagging module 222 includes an item 230. For example, the media content 224 can be a video content that includes an item 230 such as an object. The object can be, for example, one of a piece of furniture, a food item, an article of clothing, a piece of jewelry and/or the like. In some embodiments, however, the item 230 in the media content 224 can be auditory such as a song or a spoken pronunciation of a particular television show. In some embodiments, the item 230 in the media content 224 can be a location such as a city, town or building. In some embodiments, the media content 224 can include more than one item 230.

The server 212 is configured to transmit data or facilitate the transmission of data to the tagging module 222 via the tagging platform 220. Specifically, the server 212 is configured to transmit the media content 224 to the tagging platform 220 such that the media content 224 is displayed in the tagging module 222. In some embodiments, the media content 224 can be transmitted to the tagging platform 220 over a network such as the Internet, intranet, a client server computing environment and/or the like. In some embodiments, the media content 224 can be streamed to the tagging platform 220. In some embodiments, the server 212 can include a ColdFusion/SQL server application such that the data exchanged between the server 212 and the tagging platform 220 is performed by, for example, XML/delimited lists mixed with JSON or JSON alone. In other embodiments, the server 212 can include an Adobe ColdFusion/Java server application.

In some embodiments, the tagging module 222 obtains metadata associated with the media content 224 before the media content 224 can be displayed in the tagging module 222. For example, the tagging module 222 can be configured to request the metadata associated with the media content 224 from the server 212. The metadata can include, for example, the filenames/paths that facilitate the display of the media content 224. The request from the tagging module 222 can be sent via Flash Remoting to the server 212 using HTTP. The server 212 can be configured to transmit the requested metadata to the tagging module 222 via JSON. Once the tagging module 222 receives the metadata from the server 212, the tagging module 222 can upload the media content 224 from a media server via RTMP and/or HTTP.

In use, a user can initiate a tagging event by actuating the indicia 226 in the tagging module 222. For example, the indicia 226 can be actuated by a user selecting the indicia 226 via a computer mouse when the tagging module 222 is displayed on a computer monitor. In some embodiments, the indicia 226 can be illustrated on the computer monitor as, for example, a soft button, symbol, image or any suitable icon.

Once the indicia 226 is actuated by the user, the tagging module 222 facilitates the input of data related to the item 230 from the media content 224 by the user. Such an input can be, for example, a description of the item 230 from the media content 224 including key words to identify the item 230. In some embodiments, the input can be a URL for a website that contains information related to the item 230 from the media content 224 such as purchase information, user reviews for the item 230, articles about the item 230 and/or the like. For example, a user wanting to tag an item 230, such as a song in the media content 224, can activate the indicia 226 such that a text box appears in the tagging module 222. The user can then input a description of the song in the text box. The user, for example, can input one or more words that identifies the song, such as the artist or the name of the song. In some embodiments, the input can be specific to the item 230 (e.g., the name of the song, or lyrics of the song). In some embodiments, the input can relate generally to the item 230 (e.g., the genre of the song).

The user input is transmitted from the tagging module 222 to the server 212 via the tagging platform 220. In some embodiments, the transmission can be initiated by the activation of another indicia (not shown) in the tagging module 222. After receiving the user input, the server 212 is configured to transmit the user input to the third-party 240. In some embodiments, the server 212 transmits the user input to the third-party 240 over an open API. Using the user input, the third-party 240 can search its database for products that are related to the item 230 from the media content 224. For example, from the embodiment above, if the user had input the name of the artist of the song from the media content 224, the third-party 240 can use that name of the artist to search for all the products within its database that relate to the artist. Such products can include all the songs written by the artist, all songs featuring the artist, books published on/by the artist, and/or the like. In some embodiments, the third-party 240 can prompt the user for additional input related to the item 230 from the media content 224 when an excessive amount of products are found. In some embodiments, the third-party 240 can automatically filter through the related products based on most commonly related purchased products.

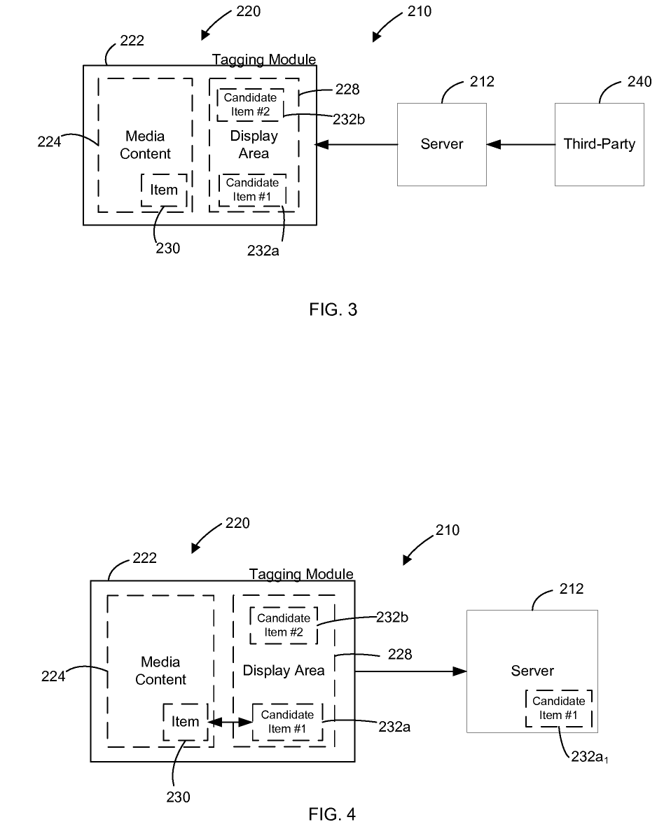

The third-party 240 transmits the data related to the retail products to the server 212, as shown in FIG. 3. The server 212 then transmits the data to the tagging platform 220 such that the related retail products (e.g., candidate items 232a and 232b) are displayed in the tagging module 222. Specifically, as shown in FIG. 3, the tagging module 222 includes a display area that displays the candidate items 232a and 232b. Although the third-party 240 is illustrated and described as transmitting data related to multiple candidate items 232a and 232b, in some embodiments, the third-party 240 can transmit data related to a single candidate item (e.g., 232a or 232b) such that only the single candidate item is displayed in the display area 228 of the tagging module 222. In some embodiments, however, the third-party 240 can transmit data related to more than two candidate items such that the candidate items 232a and 232b are displayed in the display area 228 of the tagging module 222 along with the additional candidate items.

The display 228 of the tagging module 222 is interactive and allows the user to select the most suitable candidate item (i.e., either 232a or 232b) to associate with the item 230 from the media content 224. Continuing with the example illustrated above, the user could have input a general description of the desired-song such as the artist of the song. As a result, the third-party 240 could return data such that candidate item 232b could be a different song from the artist and candidate item 232a could be the same song from the media content 224 from the artist. In theory, the user would choose candidate item 232a such that the item 230 from the media content would be associated with the candidate item 232a. In some embodiments, however, the user can choose more than one candidate item to associate with the item 230.

Once the user designates the most appropriate candidate item (e.g., candidate item 232a), that candidate item becomes associated with the item 230 from the media content 224, as illustrated by the arrow in FIG. 4. The tagging platform 220 then sends the data related to the chosen candidate item 232a to the server 212. The server 212 stores the data 232a₁ from the chosen candidate item 232a for future use. In some embodiments, the server 212 and/or some other storage device can save the data related to the candidate item 232b for future use. In some embodiments, the server 212 includes a database (not shown) that can be configured to store the data 232a₁.

In some embodiments, the server 212 can be configured to embed the data 232a₁ from the associated candidate item 232a within the metadata stream of the media content 224. Specifically, the server 212 can include computer software and algorithms to create a data-embedded media content 224. The software and the algorithms of the server 212 can embed the data 232a₁ associated with the items 230 from the media content 224 to generate a data-embedded media content 224. In some embodiments, a single media content 224 can have any number of items 230 that can be tagged. For example, in some embodiments, the media content 224 can include thousands of items 230 that can be tagged such that the data from the thousands of associated candidate items can be embedded within or associated with the media content 224.

Although the above description and illustration of a tagging event is directed toward the tagging of a single item 230 from the media content 224 at a specific instance in the media content 224, in some embodiments, the tagging of the item 230 from the media content 224 applies to each instance the item 230 appears in the media content 224. Specifically, once an item 230 from the media content 224 is tagged each instance of the item 230 in the media content 224 becomes tagged automatically. In some embodiments, however, the user tagging the item 230 from the media content 224 can manually tag each instance of the item 230 in the media content 224. For example, once the item 230 is tagged by the user in the manner described above, the user can be prompted by the tagging platform 220 to input each instance during the media content 224 that the item 230 appears. Such an input can include, for example, the minute and/or second during the media content 224 that the item 230 appears.

In some embodiments, the user tagging the media content 224 is a third-party unaffiliated with the company that maintains the back-end system 210 and/or owns the media content 224. For example, the user can be a college student that tags the media content 224 in their spare time. In this manner, the tagging platform 220 can be accessible to any qualified user. In some such embodiments, the company described above can compensate the user for each tag that is made in the media content 224. For example, each tag that the user makes could result in a 3 cent compensation. In addition, in some embodiments, the user can be compensated by the company and/or the third-party 240 when the item 230 that they tagged is purchased by a consumer from the third-party 240 via the front-end of the system, as described herein. As a result, the user can make earnings based on the tags, while the company pays a minimal amount for the tagging. In some embodiments, the company can be compensated by the third-party 240 when a tagged item 230 is purchased by a consumer from the third-party 240.

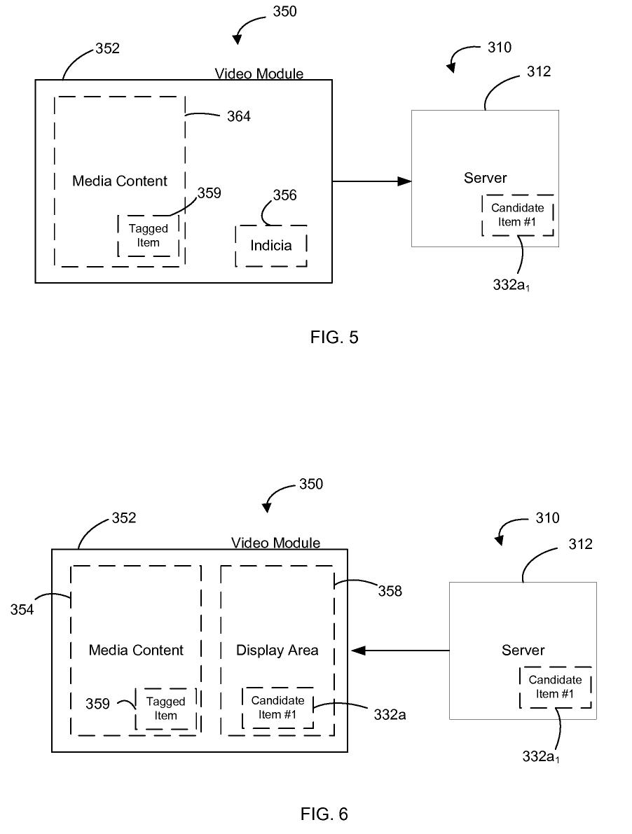

FIGS. 5 and 6 are schematic illustrations of a front end 350 and the server 212 according to an embodiment. The server 212 includes data 332a₁ related to a candidate item 332a (shown in FIG. 6). The server 212 is configured to communicate with the front end 350. The front end 350 includes a video module 352 that is configured to display media content 354 and an indicia 356. The front end 350 can be configured to operate on, for example, a personal computer, television, PDA, or any other media viewing device or set of devices that are capable of presenting media. For example, in some embodiments, the front end 350 can operate on a personal computer such that the video module 352 is displayed on the GUI of the personal computer. The indicia 356 is configured to initiate an event when the indicia 356 is actuated. The video module 352 can be a media player configured to display the media content 354. For example, in some embodiments, the video module 352 can be one of a Flash, Flex, Flash/HTML/AJAX hybrid and/or the like. In some embodiments, the media content 354 can be a video content, an audio content, still frames or any suitable content capable of being displayed or presented in the video module 352.

The media content 354 displayed on the video module 352 includes a tagged item 359. The media content 354 can be, for example, a video content that includes a tagged item 359 such as an object. The object can be, for example, one of a piece of furniture, a food item, an article of clothing, a piece of jewelry and/or the like. In some embodiments, however, the tagged item 359 in the media content 354 can be auditory such as a song or a spoken pronunciation of a particular television show. In some embodiments, the tagged item 359 in the media content 354 can be a location such as a city, town or building. In some embodiments, the media content 354 can include more than one tagged item 359.

The tagged item 359 is associated with the candidate item 332a whose data 332a₁ is stored within the server 212. More particularly, the candidate item 332a is a retail item from a retail store that is substantially or exactly the same product as the tagged item 359. The data 332a₁ related to this candidate item 332a can be, for example, product information, purchase information, a thumbnail image of the candidate item 332a and/or the like. In some embodiments, the data 332a₁ can be considered metadata related to the candidate item 332a.

In some embodiments, the server 212 is configured to transmit data to the front end 350. Specifically, the server 212 can be configured to transmit the media content 354 to the video module 352 such that the media content 354 is displayed in the video module 352. In some embodiments, the media content 354 can be transmitted to the video module 352 over a network such as the Internet, intranet, a client server computing environment and/or the like. In other embodiments, the media content 354 can be streamed to the video module 352.

In some embodiments, the video module 352 obtains metadata associated with the media content 354 before the media content 354 is displayed in the video module 352. For example, the video module 352 can request the metadata associated with the media content 354 from the server 212. The metadata can include, for example, the filenames/paths that facilitate the display of the media content 354. The request from the video module 352 can be sent via Flash Remoting to the server 212 using HTTP. The server 212 can transmit the requested metadata to the video module 352 via JSON. Once the video module 352 receives the metadata from the server 212, the video module 352 can upload the media content 354 from a media server via RTMP and/or HTTP.

In use, a consumer viewing the media content 354 can actuate an event by actuating the indicia 356 in the video module 352 to obtain more information on a tagged item 359 from the media content 354. In some embodiments, the indicia 356 can be present for the entire duration of the media content 354 whether or not there is a tagged item 359 present at that instance of the media content 354, as described herein. In some embodiments, however, the indicia 356 only appears in the video module 352 when a tagged item 359 is present at that instance of the media content 354.

Upon activation of the indicia 356, the video module 352 transmits a request to the server 212 for the data 332a₁ associated with the tagged item 359 from the media content 354. In some embodiments, the video module 352 can send the request for the data 332a₁ via Flash Remoting to the server 212 using HTTP. Based on the request from the video module 352, the server 212 transmits the data 332a₁ to the video module 352 such that the data 332a₁ is displayed in a display area 358 of the video module 352 as the related candidate item 332a. In some embodiments, the server 212 can transmit the data 332a₁ to the video module 352 via JSON. In some embodiments, the candidate item 332a can be displayed as text describing the candidate item 332a. In some embodiments, the candidate item 332a can be displayed as a thumbnail image of the candidate item 332a. In other embodiments, each time the indicia 356 is actuated, all of the data associated with any tagged items 359 in the particular media content 364 are displayed regardless of whether the tagged item 359 is displayed when the indicia 356 is actuated.

In some embodiments, the media content 354 can be divided into portions such that particular tagged items 359 are associated with particular portions of the media content 354. For example, the media content 354 could be a video content having a car-chase scene and a conversation scene where each scene is related to a particular portion of the media content 354. In each scene (i.e., portion) there can be an associated tagged item such as a car from the car-chase scene and a chair from the conversation scene. As a result, the activation of the indicia 356 during a particular portion of the media content 354 would only acquire the data related to the tagged items 359 from that particular portion. For example, the activation of the indicia 356 during the conversation scene would result in the acquiring of data related to the tagged chair and not the tagged car from the car-chase scene. In some embodiments, however, the activation of the indicia 356 can result in the acquiring of data from all tagged items 359 in the media content 354 and/or a set of portions of the media content 354.

In some embodiments, the video module 352 can include an indicia (not shown) that the consumer can actuate to initiate a purchase event. Said another way, the consumer can decide to purchase the candidate item 332a displayed on the video module 352 by actuating an indicia (not shown). In some such embodiments, the video module 352 can be configured to inform the server 212 of the initiation of the purchase event. In some embodiments, the server 212 can direct the consumer to a third-party e-commerce retail store, via the video module 354, where they can purchase the candidate item 332a. In some embodiments, the consumer can purchase more than one candidate item 332a related to the tagged item 359 from the media content 354. In some embodiments, the consumer can be directed by the server 212 to the third-party e-commerce retail store where the consumer can purchase the candidate item 332a along with another retail item from the third-party.

In some embodiments, when a consumer purchases the candidate item 332a from the third-party via the front-end system 350, the third-party can compensate the user that tagged the item from the media content 354 related to that particular candidate item 332a. In some such embodiments, the third-party can compensate the company that maintains the front-end system 350 and/or owns the media content 354.

Although the data 332a₁ related to the candidate item 332a is illustrated and described as being stored within the server 212, in some embodiments, the media content 354 is a data-embedded media content such that the data 332a, is embedded within a metadata stream of the media content 354. In this manner, the data 332a₁ can be extracted from the metadata stream of the media content 354 rather than transmitted from the server 212.

In some embodiments, the front end 350 can include at least one SWF file and/or related Object/Embed code for browsers. In some such embodiments, the server 212 can include a ColdFusion/SQL server application such that the data exchanged between the server 212 and the front end 350 is performed by, for example, XML/delimited lists mixed with JSON or JSON alone.

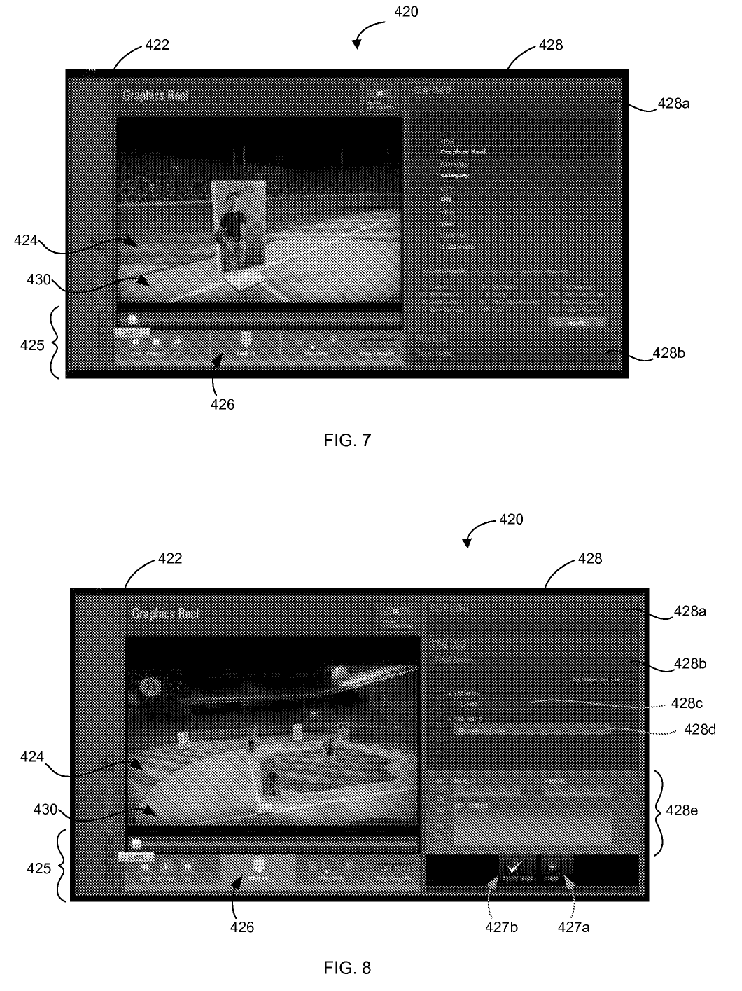

FIGS. 7-10 are examples of screen shots of a tagging platform 420 according to an embodiment. The tagging platform 420 includes a tagging module 422 which is configured to run on the tagging platform 420. The tagging platform 420 is a computing platform that is configured to operate on, for example, a personal computer, television, PDA, or any other media viewing device or set of devices that are capable of presenting media. For example, in some embodiments, the tagging platform 420 operates on a personal computer such that the tagging module 422 is displayed on the GUI of the personal computer. The tagging platform 420 is configured to facilitate the display of the tagging module 422 on a device capable of presenting media.

The tagging module 422 includes a display area 428 and is configured to display a video content 424, an tag indicia 426 and a control panel 425. The tagging module 422 is an interactive media player configured to display the video content 424. For example, in some embodiments, the tagging module 422 can be one of a Flash, Flex, Flash/HTML/AJAX hybrid and/or the like. The video content 424 includes at least one item 430 that can be tagged. An item 430 can be, for example, an object, auditory, or a location, as described above. For the purposes of this embodiment, the baseball field from the video content 424 is the item 430. In some embodiments, however, any one of the baseball cards from the video content 424 can be an item 430. In some embodiments, the video content 424 can include more than one item 430. The tag indicia 426 (labeled “tag it”) is configured to initiate a tagging event when the tag indicia 426 is actuated. In this manner, the item 430 (i.e., the baseball field) can be tagged.

The control panel 425 is configured to control the operation of the video content 422 in the tagging module 422. The control panel 425 includes transport controls such as play, pause, rewind, fast forward, and audio volume control. Additionally, the control panel 425 includes a time bar that indicates the amount of time elapsed in the video content 424. In some embodiments, the control panel 425 can include a full screen toggle. Additionally, in some embodiments, such transport controls can be configured to load and read XML playback events as well as initiate events. In some such embodiments, the control panel 425 can include the tag indicia 426.

The display area 428 is configured to display information related to the video content 424. Specifically, the display area 428 includes a “clip info” field 428a and a “tag log” field 428b that can be expanded and minimized by clicking on the respective field. The “tag log” field 428b includes information related to tagged items in the video content 424 including the total number of tagged items in the video content 424. The “clip info” field 428a includes information related to the video content 424 itself. The user can view the contents of the “clip info” field 428a, for example, by clicking on the “clip info” field 428a. As shown in FIG. 7, the display area 428 can display the contents of the “clip info” field 428a, which includes the title of the video content 424, the category that the video content 424 would be categorized as (e.g., sports), the duration of the video content 424, the city, and the year of the video content 424. The city of the video content 424 can correspond to the city that the video content 424 was filmed and/or the city that a user that uploaded the video content 424 resides in. Similarly, the year of the video content 424 can correspond to the year that the video content 424 was filmed and/or the year that the video content 424 was uploaded. Additionally, the display area 428 includes information on the video content 424 such as the TV content rating of the video content 424, as shown in FIG. 7. For example, in some embodiments, the video content 424 can include violent content such that the video content 424 can be labeled “V” to denote such content. In some embodiments, the user tagging the video content 424 can choose the TV content rating of the video content 424. In some embodiments, the information related to the video content 424 that is displayed in the display area 428 of the tagging module 422 can be embedded in a file associated with the video content 424 or streamed with the video content 424.

In use, a user can initiate a tagging event by actuating the tag indicia 426 in the tagging module 426. Specifically, when the user wants to tag an item 430 from the video content 424, the user actuates the tag indicia 426 to start the tagging process. The tag indicia 426 can be actuated, for example, by the user selecting the tag indicia 426 via a computer mouse when the tagging module 422 is displayed on a GUI. Although the tag indicia 426 is labeled and displayed as a soft button in the tagging module 422, in some embodiments, the tag indicia 426 can be illustrated on the GUI, for example, as a symbol, image or any other suitable icon.

As shown in FIG. 8, the tag indicia 426 is highlighted, which indicates that it has been actuated by the user. As a result, the video content 424 is automatically paused and the information displayed in the display area 428 of the tagging module 422 changes. Specifically, the “clip info” field 428a and the “tag log” field 428b of the display area 428 are minimized such that the display area 428 then includes an add indicia 427a, a test tag indicia 427b, and several textbox fields where the user can enter information related to the item 430 to be tagged. The add indicia 427a and the test tag indicia 427b are soft buttons. The add indicia 427a is configured to complete the tagging process (i.e., the tagging event) when it is actuated. The test tag indicia 427b is configured to test a previously tagged item to ensure that that item is correctly tagged when the test tag indicia 427b is actuated. The textbox fields of the display area 428 include a location field 428c, a tag name field 428d, and an optional user input section 428e, which includes a vendor field, a product field, and a key words field. The location field 428c is configured to record the instance that the tag indicia 426 was actuated by the user. In some embodiments, that instance can be automatically recorded by the tagging module 422 and included in the location field 428c. In some embodiments, that instance can be manually recorded by the user in the location field 428c. In some such embodiments, the user can determine the instance of the actuation by scrolling a computer mouse over the time bar which causes the elapsed time of the video content 424 to appear. The tag name field 428d can be filled out by the user and can be any word or set of words that describe the item 430 from the video content 424 that will be tagged. For example, the description provided in the tag name field 428d in FIG. 8 is, appropriately, “baseball field” since the item 430 from the media content 424 that the user wants to tag is the baseball field. In some embodiments, the user can fill out the option user input section 428e (e.g., the vendor, product and key words fields) when such information is available to them. For example, a user that has tagged similar items from video content in the past may have such information in their possession already. In such cases, the user can tag the item 430 from the video content 424 by manually filling out the related fields and clicking (i.e., actuating) the “add” indicia 427a. In some embodiments, the textbox fields can be included as part of the “tag log” field 428b.

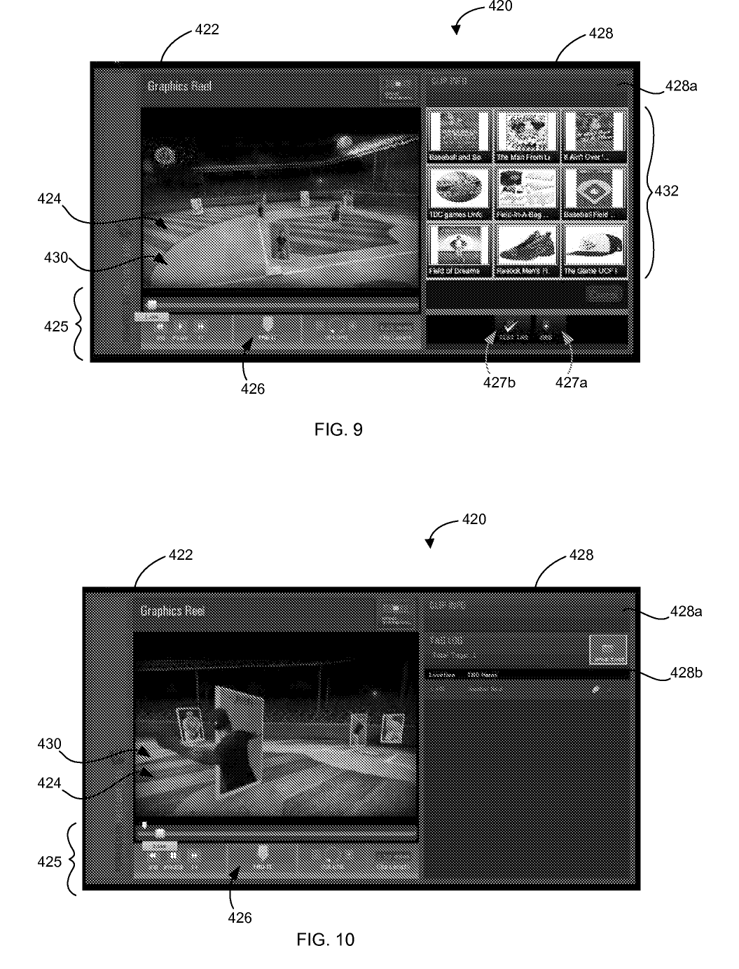

As shown in FIG. 9, a list of candidate items 432 appear in the display area 428 after the tag name has been entered into the tag name field 428d. In some embodiments, an indicia (not shown) can be actuated to generate the list and/or to initiate the display of such list in the display area 428. Each candidate item 432 from the list of candidate items 432 is a retail item related to the item 430 from the video content 424. Specifically, each candidate item 432 is related to a baseball field. In some embodiments, the candidate items 432 can be provided by a third-party, such as, for example, an e-commerce retail store like Amazon®, as described above. Although the list of candidate items 432 are illustrated in FIG. 9 as a list of thumbnail images, in some embodiments, the list of candidate items 432 can be displayed in the display area 428 of the tagging module 422 as a list of text descriptions of each candidate item 432.

The user can choose a candidate item from the list of candidate items 432 displayed in the display area 428 to associate with the item 430 from the video content 424. Similarly stated, the user can choose a candidate item from the list of candidate items 432 displayed in the display area 428 that is most related to the item 430 from the video content 424. Once the candidate item is identified, the user can actuate the “add” indicia 427a in the display area 428 to tag the item 430 from the video content 424. Simultaneously, the video content 424, which was paused throughout the tagging process, begins to play again.

As shown in FIG. 10, the item 430 (i.e., the baseball field) from the video content 424 is tagged and listed in the “tag log” field 428b in the display area 428. In the “tag log” field 428b, the user can edit the tagged item 430 and/or delete the tagged item 430. For example, the user can choose to associate the item 430 from the video content 424 with another candidate item from the list of candidate items 432 and/or change the description of the item 430 in the tag name field 428d. The “tag log” field 428b includes a “save tags” file so that the user can choose to save the tagged item 430. In some embodiments, the tagging module 422 and/or the tagging platform 420 can be configured to embed the saved data related to the tagged items 430 within a metadata stream of the video content 424 such that any subsequent viewing of the video content 424 includes the data related to the tagged items 430.

In some embodiments, the list of tags in the “tag log” field 428b can be used to tag the item 430 when it appears in the video content 424 at a later instance. For example, the baseball field (i.e., the item 430) that was tagged 1.488 seconds into the video content 424 can reappear 1 minute into the video content 424. In some such embodiments, the user can duplicate the tag for the baseball field 1.488 seconds into the video content 424 for the baseball field 1 minute into the video content 424.

In some embodiments, the video content 424 can be any media content such as an audio content, still frames or any suitable content capable of being displayed in the tagging module 422. In some embodiments, the video content 424 can include an audio content or any other suitable content capable of being displayed in the tagging module 422 with the video content 424.

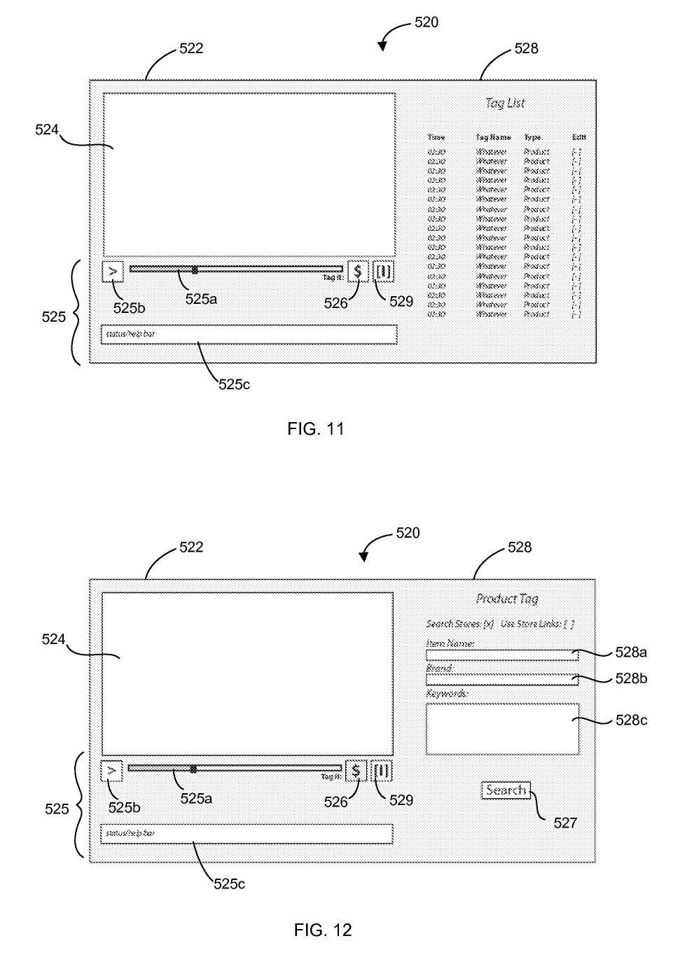

FIGS. 11-14 are schematic illustrations of a tagging platform 520 according to an embodiment. The tagging platform 520 includes a tagging module 522 which is configured to run on the tagging platform 520. The tagging platform 520 is a computing platform that is configured to operate on, for example, a personal computer, television, PDA, or any other media viewing device or set of devices that are capable of presenting media. For example, in some embodiments, the tagging platform 520 operates on a personal computer such that the tagging module 522 is displayed on the GUI of the personal computer. The tagging platform 520 is configured to facilitate the display of the tagging module 522 on a device capable of presenting media.

The tagging module 522 includes a display area 528 and is configured to display a media content 524, a tag indicia 526, an info indicia 529 and a control panel 525. The tagging module 522 is an interactive media player configured to display the media content 524. For example, in some embodiments, the tagging module 522 can be one of a Flash, Flex, Flash/HTML/AJAX hybrid or the like. The media content 524 includes at least one item (not shown) that can be tagged. An item can be, for example, an object, auditory, or a location, as described above. In some embodiments, the media content 524 can be, for example, a video content, an audio content, a still frame and/or the like. In some embodiments, the media content 524 can include more than one item. The tag indicia 526 is a soft button identifiable by a dollar sign (“$”) symbol. The tag indicia 526 is configured to initiate a tagging event associated with purchase information when the tag indicia 526 is actuated. The info indicia 529 is a soft button identifiable by an information (“[i]”) symbol. The info indicia 529 is configured to initiate a tagging event associated with product information when the info indicia 529 is actuated.

The control panel 525 is configured to control the operation of the media content 522 in the tagging module 522. The control panel 525 includes a time bar 525a, a toggle button 525b and a help bar 525c (labeled as “status/help bar”). The help bar 525c is a textbox where a user having technical difficulties using the tagging platform 520 can type in, for example, a keyword, and receive in return instructions on how to fix a problem associated with the keyword. In some embodiments, the help bar 525c can be a soft button such that the user can actuate the help bar 525c and receive help on a particular technical difficulty or question related to the use of the tagging platform 520. The toggle button 525b is a soft button that is configured to advance the media content 524, for example, to its next frame, when it is actuated. In this manner, the toggle button 525b is configured to advance the time bar 525a some increment when the toggle button 525b is actuated. The time bar 525a is configured to indicate the amount of time elapsed in the media content 524 such that the position of the time bar 525a corresponds to the elapsed time of the media content 524. Additionally, the time bar 525a is configured to control the viewing of the media content 524. For example, the time bar 525a can fast forward the media content 524 by sliding the time bar 525a to the right and rewind the media content 524 by sliding the time bar 525a to the left. In some embodiments, the control panel 525 can include transport controls such as play, pause, rewind, fast forward, and audio volume control. In some embodiments, such transport controls can be configured to load and read XML playback events as well as initiate events. In some such embodiments, the control panel 525 can include the tag indicia 526 and/or the info indicia 529.

The display area 528 is configured to display information related to the media content 524 including tagging information, as described herein. As shown in FIG. 11, before a tagging event is initiated, the display area 528 includes a tag list which lists all of the tagged items from the current media content 524. The list includes the instance that the tagged item appears in the media content 524, the name of the tagged item, the type of tagged item, and presents an option to the user to edit the tagged item. The instance that the tagged item appears in the media content 524 can be represented, for example, by a time increment associated with the total elapsed time of the media content 524, by a particular frame of the media content 524 and/or the like. The name of the tagged item can be one or more words that describe the tagged item. In some embodiments, the name of the tagged item can include a thumbnail image of the tagged item. The type of tagged item can be, for example, a product. In some embodiments, the type of tagged items can be more specific such as the type of product, which could be, for example, a song, a household appliance, jewelry, furniture, and/or the like.

In use, a user can initiate a tagging event associated with purchasing information by actuating the tag indicia 526 in the tagging module 522. Specifically, when the user wants to tag an item from the video content 524 and associate that item with purchasing information, the user actuates the tag indicia 526 to start the tagging process. The tag indicia 526 can be actuated, for example, by the user selecting the tag indicia 526 via a computer mouse when the tagging module 522 is displayed on a GUI. Although the tag indicia 526 is labeled and displayed as a soft button in the tagging module 522, in some embodiments, the tagging indicia 526 can be illustrated on the GUI, for example, as a symbol, image or any other suitable icon.

As shown in FIG. 12, the tag indicia 526 is actuated by the user. As a result, the display area 528 of the tagging module 522 changes from a display of a tag list to a display of information related to a product tag. The product tag display includes several textbox fields and a search indicia 527, and provides the user with two options for creating a product tag associated with purchasing information, both of which are described in detail herein. The several textbox fields include an item name textbox 528a, a brand textbox 528b, and a keywords textbox 528c each where the user can enter information related to the item from the media content 524 to be tagged. The item name textbox 528a can be any word or set of words that describe the item from the media content 524 that is being tagged. Specifically, the item name textbox 528a will be used to identify the tagged item, for example, in future viewings of the media content 524. The brand textbox 528b can be any company and/or brand that sells and/or manufactures the item from the media content 524 that is being tagged. The keywords textbox 528c, similar to the item name textbox 528a, can be any word or set of words that describe the item from the media content 524 that is being tagged. The first option is labeled as a “search stores” option and the second option is labeled as a “user store links” option. In some embodiments, the first option and/or the second option can be soft buttons such that a user can select the option via actuation of the soft button.

The search indicia 527 is a soft button that is configured to initiate a search event when actuated by the user. Specifically, the input provided by the user in the textboxes 528a-c is sent to at least one third-party (not shown) via the tagging platform 520 when the search indicia 527 is actuated. Each third-party, which can be, for example, an e-commerce retail store, can search its database for retail items related to the described item from the media content 524 and return a list of retail items (i.e., candidate items 532) that are substantially the same as or identical to the item from the media content 524 that is being tagged.

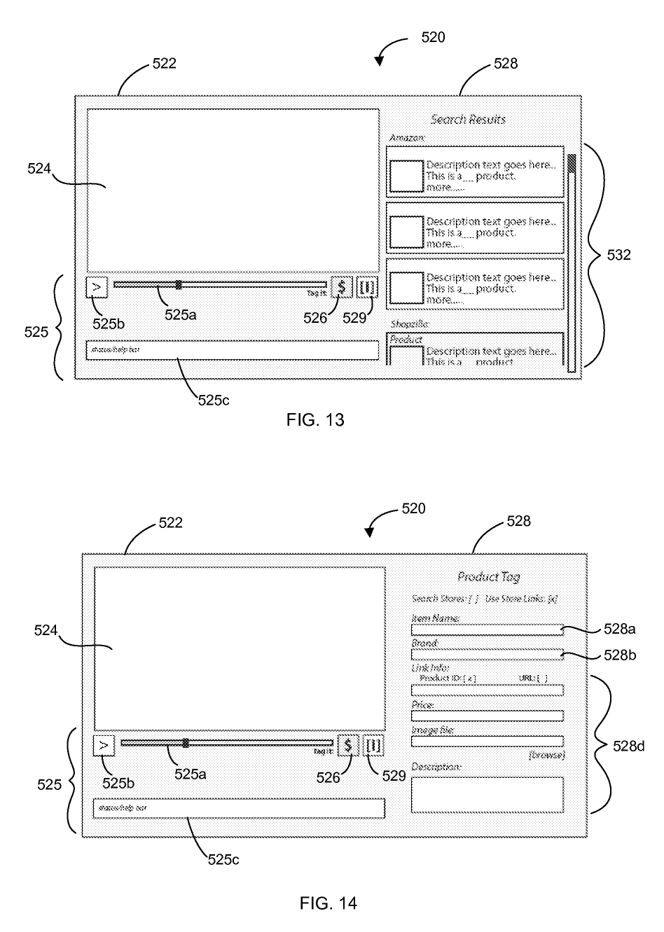

In FIG. 12, the user selects the first “search stores” option as indicated by the “x”. As shown in FIG. 13, a list of candidate items 532 appear in the display area 528 after the search indicia 527 is actuated. Each candidate item from the list of candidate items 532 is a retail item related to the item from the video content 524, as described above. Each of the candidate items are identified by a thumbnail image and a short description. In some embodiments, however, the candidate items can be identified only by the thumbnail image or the short description. The list of candidate items 532 are grouped according to their respective third-party origins. For example, each of the candidate items that derived from Amazon® are listed under the “Amazon” label. Similarly, each of the candidate items that derived from Shopzilla® are listed under the “Shopzilla” label. In some embodiments, there can be multiple third-parties with corresponding candidate items listed in the search results.

The user can choose a candidate item from the list of candidate items 532 displayed in the search results of the display area 528 to associate with the item from the media content 524. Similarly stated, the user can choose a candidate item from the list of candidate items 532 displayed in the display area 528 that is most related to the item 530 from the media content 524. Once the candidate item is identified, the item from the media content 524 is tagged such that it is associated with the selected candidate item.

In some instances, the user may choose to select the second “use store links” option as indicated by the “x”. As shown in FIG. 14, the display area 528 changes such that the keywords textbox 528c disappears and a set of link info textboxes 528d appear. The link info textboxes 528d include a text box related to either the product ID or a URL, a price text box, an image file text box, and a description text box. The user can input the price of the item from the media content 524 in the price text box. The user can upload an image related to the item from the media content 524 in the image file text box. Specifically, the user can click on the “browse” icon below the image file text box to search the files of the hard-drive on the device running the tagging platform 520 and choose an image from those files. The user can input a word or set of words to describe the item from the media content 524 in the description text box. The product ID/URL textbox is configured to accept input related to either a product ID of the item from the media content 524 or a URL of a web address where the item from the media content 524 can be purchased. In this manner, the item from the media content 524 is tagged via the product ID or the URL.

Returning to FIG. 11, a user can initiate a tagging event associated with product information by actuating the info indicia 526 in the tagging module 522. Specifically, when the user wants to tag an item from the video content 524 and associate that item with product information, the user actuates the info indicia 529 to start the tagging process. The info indicia 529 can be actuated, for example, by the user selecting the info indicia 529 via a computer mouse when the tagging module 522 is displayed on a GUI. Although the info indicia 529 is labeled and displayed as a soft button in the tagging module 522, in some embodiments, the info indicia 529 can be illustrated on the GUI, for example, as a symbol, image or any other suitable icon.

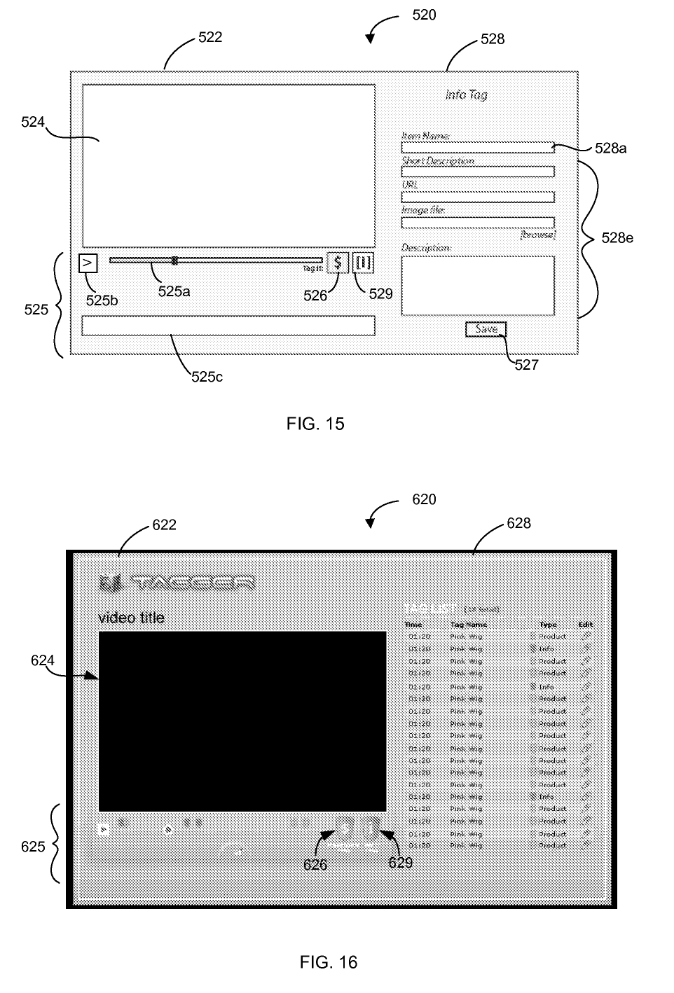

As shown in FIG. 15, the info indicia 529 is actuated by the user. As a result, the display area 528 of the tagging module 522 changes from a display of a tag list to a display of information related to an info tag. The info tag display includes several textbox fields and a save indicia 527. The several textbox fields include an item name textbox 528a and a set of info tag textboxes 528e, each where the user can enter information related to the item from the media content 524 to be tagged. The set of info tag textboxes 528e include a short description textbox, a URL textbox, an image file textbox, and a description textbox. The URL textbox, image file textbox and the description textbox are substantially similar to or the same as the textboxes illustrated in FIG. 14 with respect to the set of link info textboxes 528d. The save indicia 527 is configured to be actuated by the user and to save the input from the textboxes 258a and 528e. In this manner, the item from the media content 524 is tagged.

In some embodiments, the media content 524 that is displayed or presented on the tagging module 522 can be automatically paused as soon as the tag indicia 526 or the info indicia 529 is actuated by the user. Once the item from the media content 524 has been tagged, the media content 524, which was paused throughout the tagging process, begins to play again. In some embodiments, after the item from the media content 524 has been tagged, data related to the tagged item can be embedded within a metadata stream of the media content 524 such that any subsequent viewing of the media content 524 includes the data related to the tagged item.

FIG. 16 is a perspective view of a tagging platform 620 according to an embodiment. The tagging platform 620 includes a tagging module 622 which is configured to run on the tagging platform 620. The tagging platform 620 is a computing platform, as described above. The tagging platform 620 is configured to facilitate the display of the tagging module 622 on a device capable of presenting media, as described above.

The tagging module 622 includes a display area 628 and is configured to display a media content 624, a tag indicia 626, an info indicia 629 and a control panel 625. The tagging module 622 is an interactive media player configured to display the media content 624, as described above. The media content 624 includes at least one item (not shown) that can be tagged. An item can be, for example, an object, auditory, or a location, as described above. The tag indicia 626 is a soft button identifiable by a dollar sign (“$”) symbol. The tag indicia 626 is configured to initiate a tagging event associated with purchase information when the tag indicia 626 is actuated, as described above. The info indicia 629 is a soft button identifiable by an information (“[i]”) symbol. The info indicia 629 is configured to initiate a tagging event associated with product information when the info indicia 629 is actuated, as described above.

The control panel 625 is configured to control the operation of the media content 622 in the tagging module 622. The control panel 625 includes a time bar configured to indicate the amount of time elapsed in the media content 624 such that the position of the time bar corresponds to the elapsed time of the media content 624. Along the length of the time bar are indicators associated with tagged items in the media content 624. Specifically, the darker indicators indicate instances of tagged items associated with purchasing information and the lighter indicators indicate instances of tagged items associated with product information. Additionally, the time bar is configured to control the viewing of the media content 624, as described above. In some embodiments, the control panel 625 can include transport controls such as play, pause, rewind, fast forward, and audio volume control. In some embodiments, such transport controls can be configured to load and read XML playback events as well as initiate events. In some such embodiments, the control panel 625 can include the tag indicia 626 and/or the info indicia 629.

The display area 628 is configured to display information related to the media content 624 including tagging information, as described herein. As shown in FIG. 16, the display area 628 includes a tag list which lists all of the tagged items from the current media content 624. The list includes the instance that the tagged item appears in the media content 624, the name of the tagged item, the type of tagged item, and presents an option to the user to edit the tagged item. The instance that the tagged item appears in the media content 624 can be represented, for example, by a time increment associated with the total elapsed time of the media content 624, by a particular frame of the media content 624 and/or the like. The name of the tagged item can be one or more words that described the tagged item. In some embodiments, the name of the tagged item can include a thumbnail image of the tagged item. The type of tagged item can be, for example, a product. In some embodiments, the type of tagged items can be more specific such as the type of product which could be, for example, a song, a household appliance, jewelry, furniture, and/or the like.

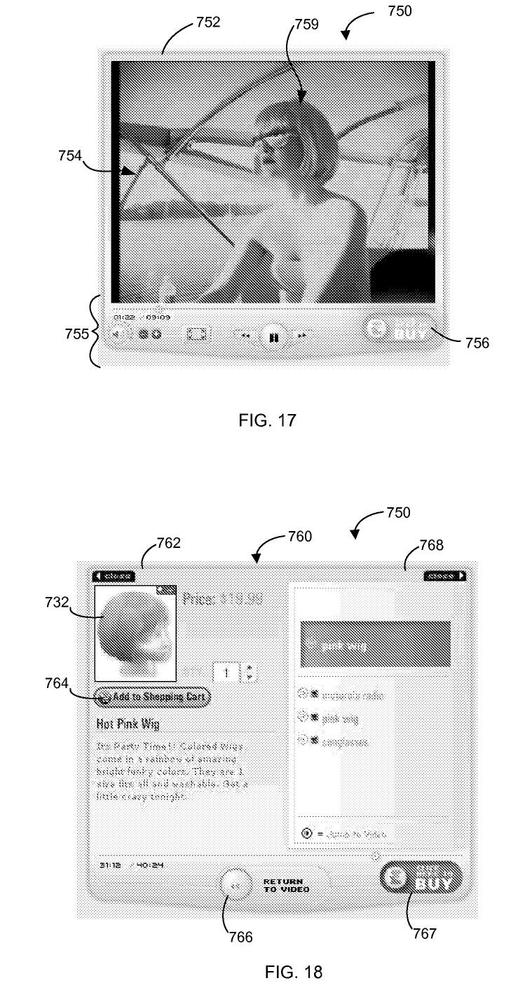

FIGS. 17 and 18 are perspective views of a front-end system 750 according to an embodiment. The front end 750 includes video module 752 that is configured to display video content 754, an indicia 756 and a control panel 755. The front end 750 can be configured to operate on, for example, a personal computer, television, PDA, or any other media viewing device or set of devices that are capable of presenting media. For example, in some embodiments, the front end 750 can operate on a personal computer such that the video module 752 is displayed on the GUI of the personal computer. The indicia 756 (labeled “click here to BUY”) is a soft button configured to initiate an event when the indicia 756 is actuated. The event can be associated with, for example, purchasing information or product information. The video module 752 is a media player configured to display the video content 754. For example, in some embodiments, the video module 752 can be one of a Flash, Flex, Flash/HTML/AJAX hybrid and/or the like. In some embodiments, the video content 754 can be a video content, an audio content, still frames or any suitable content capable of being displayed or presented in the video module 752.

The video content 754 displayed on the video module 752 includes a tagged item 759. As shown in FIG. 17, the tagged item is a pink wig. In some embodiments, the tagged item can be any object, auditory, or location, as described above. In some embodiments, the video content 754 can include more than one tagged item 759. The control panel 755 is configured to control the operation of the video content 754 in the video module 752. The control panel 755 includes a time bar and transport controls. The time bar is configured to indicate the amount of time elapsed in the video content 754 such that the position of the time bar corresponds to the elapsed time of the video content 754. Additionally, the time bar is configured to control the viewing of the video content 754. For example, the time bar can fast forward the video content 754 by sliding the time bar to the right and rewind the video content 754 by sliding the time bar to the left. The transport controls of the control panel 755 include transport controls such as play, pause, rewind, fast forward, and audio volume control. In some embodiments, such transport controls can be configured to load and read XML playback events as well as initiate events. In some such embodiments, the control panel 755 can include the indicia 756.

In use, a user (e.g., a consumer) viewing the video content 754 can initiate an event by actuating the indicia 756. Specifically, when the user wants to purchase the tagged item 759 and/or obtain product information related to the tagged item 759, the user actuates the indicia 756. The indicia 756 can be actuated, for example, by the user selecting the indicia 756 via a computer mouse when the video module 752 is displayed on a GUI. In some embodiments, the indicia 756 can be configured to illuminate when a tagged item 759 appears in the video content 754 at a particular instance. Similarly stated, the indicia 756 can be configured to indicate to the user that a tagged item 759 is available for purchase in that particular portion of the video content 754. Although the indicia 756 is labeled and displayed as a soft button in the video module 752, in some embodiments, the indicia 756 can be illustrated on the GUI, for example, as a symbol, image or any other suitable icon.

As shown in FIG. 18, a widget 760 appears when the indicia 756 is actuated. In some embodiments, the current video content 754 is paused when the indicia 756 is actuated. The widget 760 is configured to be displayed in the front-end system 750 such that the widget 760 covers the video content 754 in the video module 752. The widget 760 includes a first display area 768 and a second display area 762. The first display area 768 is interactive and includes a list of each tagged item from the video content 754 at the instance the indicia 756 was actuated. From the list of tagged items from the video content 754, the user can select the tagged item (e.g., tagged item 759) that he/she wishes to obtain more information on. In some embodiments, the video content 754 can be divided into portions such that particular tagged items 759 are associated with particular portions of the video content 754, as described above. As a result, the actuation of the indicia 756 during a particular portion of the video content 754 would only acquire the data related to the tagged items 759 from that particular portion of the video content 754. In some embodiments, however, the actuation of the indicia 756 can result in the acquiring of data from all tagged items 759 in the video content 754 and/or a set of portions of the video content 754.

The second display area 762 includes a candidate item 732, a cart indicia 764, a video indicia 766 and a purchase indicia 767. The candidate item 732 is associated with the chosen tagged item from the first display area 768. The candidate item 732 is a retail item from a retail store that is substantially or exactly the same product as the chosen tagged item 759 from the video content 754. For the purposes of this example, the chosen tagged item is the pink wig (i.e., tagged item 759). The candidate item 732 is displayed in the second display area 762 as a thumbnail image and includes a short description (labeled “Hot Pink Wig”). Additionally, the second display area 762 displays the price of the candidate item 732 along with a quantity box. The quantity box allows the user to select the number of candidate items 732 that he/she wishes to purchase. The cart indicia 764 is a soft button (labeled “Add to Shopping Cart”) configured to add the candidate item 732 to a shopping cart when the cart indicia 764 is actuated such that the candidate item 732 can be purchased at a future time. The video indicia 766 is a soft button (labeled “Return to Video”) configured to close the widget 760 when the video indicia 766 is actuated. In this manner, the user can return to the video content 754, which will have resumed playing, when the video indicia 766 is actuated. The purchase indicia 767 is a soft button (labeled “click here to BUY”) configured to direct the user to third-party site when the user actuates the purchase indicia 767. At the third-party site, the user can purchase the candidate item 732 and/or any other candidate items that were included in the shopping cart.

In some embodiments, the video module 752 can be embedded on a web page, blog and/or the like. Specifically, consumers can link to a currently playing video content 754 or display Object/Embed code to embed the video module 752 and this video content 754 onto their own web page, blog, and/or the like.

In some embodiments, the front-end 750 can include at least one SWF file and/or related Object/Embed code for browsers.

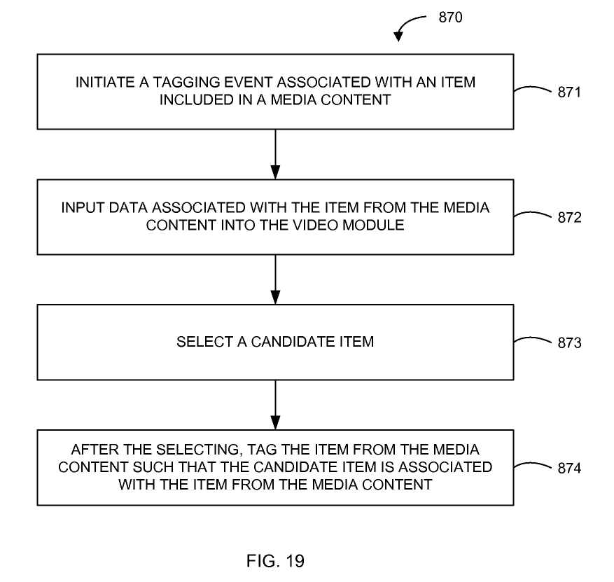

FIG. 19 is a flow chart of a method 870 according to an embodiment. The method includes initiating a tagging event associated with an item included in a media content, 871. The tagging event is initiated based on the actuation of an indicia in a video module. In some embodiments, the media content can be at least one of a video content, audio content, still frame and/or the like, as described above.

The method 870 includes inputting data associated with the item from the media content into the video module, 872. The video module is configured to display at least one candidate item related to the item from the media content based on the item data obtained from a third-party. The third-party can be, for example, an e-commerce retail store, as described above. In some embodiments, the data can be a description of the item from the media content such that the data obtained from the third-party is based on the description of the item from the media content. In some embodiments, the item data can be obtained from more than one third party, such as, for example, two different e-commerce retail stores.

The method 870 includes selecting a candidate item, 873. In some embodiments, however, more that one candidate item can be selected, as described above. In some embodiments, the candidate item can be substantially the same as or identical to the item from the media content.

The method 870 includes, after the selecting, tagging the item from the media content such that the candidate item is associated with the item from the media content, 874. In some embodiments, the tagging includes identifying each instance of the item from the media content that is included in the media content, as described above. In some embodiments, after the tagging, the method 870 further includes, storing the item data obtained by the third party associated with the candidate item. For example, in some embodiments, the item data can be stored in a database.

In some embodiments, the initiating, inputting, selecting and tagging are performed over a network.

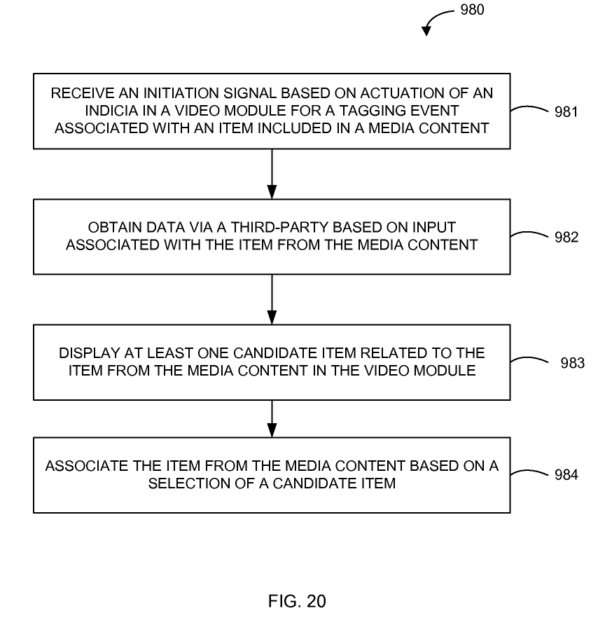

FIG. 20 is a flow chart of a method 980 according to an embodiment. The method 980 includes receiving an initiation signal based on the actuation of an indicia in a video module for a tagging event associated with an item included in a media content, 981. In some embodiments, the media content can be at least one of a video content, audio content, still frame and/or the like, as described above.

The method 980 includes obtaining data via a third-party based on input associated with the item from the media content, 982. The third-party can be, for example, an e-commerce retail store, as described above. In some embodiments, the input can be a description of the item from the media content such that the data obtained from the third-party is based on the description of the item from the media content. In some embodiments, the data can be obtained from more than one third-party, such as, for example, two different e-commerce retail stores.

The method 980 includes displaying at least one candidate item related to the item from the media content in the video module, 983. The at least one candidate item displayed in the video module is based on the data obtained from the third-party. In some embodiments, the candidate item can be substantially the same as or identical to the item from the media content.

The method 980 includes associating the item from the media content based on a selection of a candidate item, 984. In this manner, the item from the media content is tagged. In some embodiments, each instance of the item from the media content that is included in the media content can be recorded. In some embodiments, after the associating, the method 980 further includes storing the item data obtained by the third-party associated with the candidate item. For example, in some embodiments, the item data can be stored in a database.

In some embodiments, the receiving, obtaining, displaying, and associating are performed over a network.

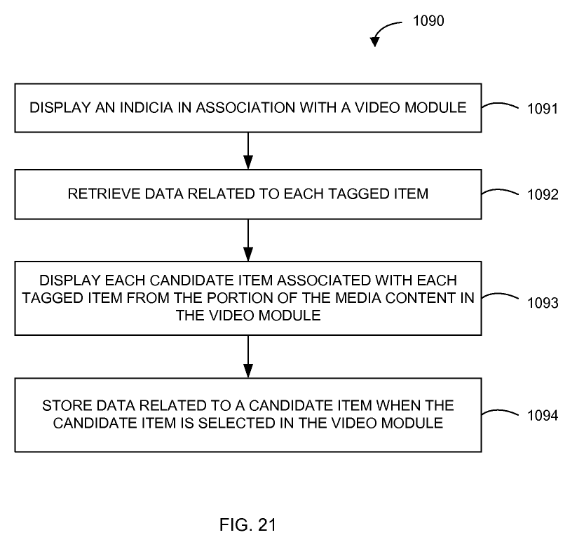

FIG. 21 is a flow chart of a method 1090 according to an embodiment. The method 1090 includes displaying an indicia in association with a video module, 1091. In some embodiments, however, the indicia is included in the video module. The indicia is associated with at least one tagged item that is included in a portion of a media content in the video module. In some embodiments, the tagged items from the portion of the media content are the tagged items from a currently displayed portion of the media content. In some embodiments, the media content can be at least one of a video content, audio content, still frame and/or the like, as described above. As a result, the portion of the media content can be, for example, a portion of a video content and/or a portion of an audio content. In some embodiments, before the displaying, the media content can be streamed from a server.

In some embodiments, the video module can be configured to be embedded as part of a web page. In some such embodiments, the video module can be embedded in more than one web page.

The method 1090 includes retrieving data related to each tagged item, 1092. The data, which includes a candidate item associated with each tagged item, is retrieved based on the actuation of the indicia. In some embodiments, the data can be retrieved from a database configured to store data related to a candidate item. In some embodiments, the data can be downloaded from a database, as described above.

The method 1090 includes displaying each candidate item associated with each tagged item from the portion of the media content in the video module, 1093. In some embodiments, however, each candidate item displayed is associated with each tagged item from the media content.

The method 1090 includes storing data related to a candidate item when the candidate item is selected in the video module, 1094. In some embodiments, the candidate item can be selected via the actuation of an indicia in the video module. In some embodiments, the selected candidate item can be purchased, which results in a compensation to at least one third-party, as described above. In some embodiments, after the storing, the method 1090 further includes sending the data related to the selected candidate item to a third-party such that the candidate item can be purchased via the third-party.

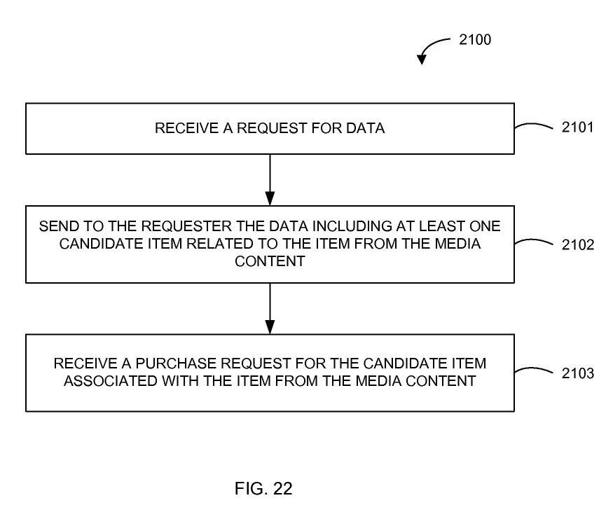

FIG. 22 is a flow chart of a method 2100 according to an embodiment. The method 2100 includes receiving a request for data, 2101. The request includes data associated with an item from a media content. In some embodiments, the data can be a description of the item from the media content. In some embodiments, the media content can be at least one of a video content, audio content, still frame and/or the like, as described above.

The method 2100 includes sending to the requester the data including at least one candidate item related to the item from the media content, 2102. At least one candidate item is associated with the item from the media content such that the data related to the at least one candidate item is stored. In this manner, the item from the media content is tagged. In some embodiments, the requester is configured to embed the data related to the at least one candidate item within the media content's metadata stream.

The method 2100 includes receiving a purchase request based on the candidate item associated with the item from the media content, 2103. In some embodiments, the purchase request can include a purchase order.

While various embodiments of the invention have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

In some embodiments, the term “XML” as used herein can refer to XML 1059, 1070, 1083, 1111 and 1112. In some embodiments, the term “HTTP” as used herein can refer to HTTP or HTTPS. Similarly, in some embodiments, the term “RTMP” as used herein can refer to RTMP or RTMPS.

In some embodiments, the tagging platform can be configured to include multiple sub-components. For example, the tagging platform could include a component such as an XML metadata reader/parser that handles events in an RTMP stream or an HTTP progressive playback of Flash compatible media files. Such events could, for example, trigger a notification component that lets consumers viewing the media content on the front-end know that there are tagged items in the current frame of the media content that they can either purchase or find out more information about, depending on the context.

In some embodiments, the video module of the front-end and the tagging module of the tagging platform of the back-end includes transport controls such as play, pause, rewind, fast forward, and full screen toggle (including audio volume control). Additionally, such transport controls can be configured to load and read XML playback events as well as initiate events.

In some embodiments, the video module of the front-end can be configured to allow consumers to perform various functions in connection with the particular media content. For example, the consumer can rate the media content. In some such embodiments, the average rating of the displayed media content can be displayed, for example, in the display area of the video module. Consumers can also add media content, or products associated with a particular media content to a “favorites” listing. Links to particular media content and/or their associated tagged content can be e-mailed or otherwise forwarded by the consumer to another potential consumer. Additionally, consumers can link to a currently playing media content or display Object/Embed code to embed the video module and this media content onto their own web page/blog.

In some embodiments, the front-end can include some back-end functionality. For example, the front-end can be configured to communicate with the third-party over an open API in the same manner as the tagging platform. In some such embodiments, a consumer viewing a media content in the front-end video module can search for a candidate item from the third-party within that video module. In this manner, the media content does not have to include tagged items for the consumer to obtain information related to items within the media content. In some embodiments, a user (or consumer) can both tag items from a media content and purchase items from the media content within the same video module.

In some embodiments, the video module from the front-end can directly link with the tagging platform from the back-end. In some such embodiments, the tagging platform can be configured to stream tagged media content directly to the video module.

In some embodiments, a user on the back-end can upload media content onto the server. In some such embodiments, the uploaded media content can be “tagged” with the user's network ID. The users can upload various file formats which can be converted to, for example, FLV, H.264, WM9 video, 3GP, JPEG thumbnails. In some embodiments, an owner of the uploaded media content can tag the media content. The owner of the media content can be, for example, the user who uploaded the media content or some other person who owns the copyright to the media content. In some embodiments, after a period of time elapses, the newly uploaded media content can be added to a “content pool” of untagged media content. At that time, anyone on the network can tag the media content. In other embodiments, the media content can only be tagged by the owner or an agent of the owner who uploaded the particular media content.

In some embodiments, a tagged item from a media content can trigger different associated events. Such events can include, for example, partner store lookups, priority ads, exclusive priority ads, and/or the like. The partner store lookups can be done at runtime, which involves initiating a search via a third-party API and presenting a product related to the tagged item in the media content to the consumer. The consumer can then choose whether to add the product to her “shopping cart”. In some embodiments, however, the product is automatically added to the consumer's “shopping cart”. Priority Ads are predefined items that are tag-word specific and display a pre-selected ad, for example, within either the first display area or second display area of the widget of the front-end. In some embodiments, however, the pre-selected ad can be displayed in some area within the video module of the front-end. Exclusive Ads are subsets of Priority Ads which do not allow for any other advertising or products displayed along with the pre-selected Priority Ad. If a media content has associated purchasable media files with it, consumers can purchase the clips.

In some embodiments, the system can have an integrated interface that allows for uploading, encoding, mastercliping, and tagging of media content. In some such embodiments, all open networks can be available for publishing of the media content. The user can be, for example, a media manager of the open network to upload. Some networks may have all users who are registered be media managers.

In some embodiments, the server can include a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate.

What is claimed is:

1. A method, comprising:
initiating a tagging event associated with an item included in a media content, the initiating based on actuation of an indicia in a video module;
inputting data associated with the item from the media content into the video module, the video module configured to display at least one candidate item related to the item from the media content, the display of the at least one candidate item based on item data obtained via a third-party;
selecting a candidate item; and
after the selecting, tagging the item from the media content such that the candidate item is associated with the item from the media content.

2. The method of claim 1, wherein the initiating, inputting, selecting and tagging are performed over a network.

3. The method of claim 1, wherein the tagging includes identifying each instance of the item from the media content being included in the media content.

4. The method of claim 1, wherein the inputting data includes inputting a description of the item from the media content such that the data obtained via the third-party is based on the description of the item from the media content.

5. The method of claim 1, wherein the candidate item is one of substantially the same as or identical to the item from the media content.

6. The method of claim 1, wherein the media content is at least one of a video content, audio content, and still frame.

7. The method of claim 1, wherein the item data is obtained from more than one third-party.

8. The method of claim 1, after the tagging, storing the item data obtained by the third-party associated with the candidate item.

9. A method, comprising:
receiving an initiation signal based on actuation of an indicia in a video module for a tagging event associated with an item included in a media content;
obtaining data via a third-party based on input associated with the item from the media content;
displaying at least one candidate item related to the item from the media content in the video module, the displaying based on data obtained via the third-party; and
associating the item from the media content based on a selection of a candidate item.

10. The method of claim 9, wherein the receiving, obtaining, displaying and associating are performed over a network.

11. The method of claim 9, wherein the associating includes recording each instance of the item from the media content being included in the media content.

12. The method of claim 9, wherein the input is a description of the item from the media content such that the data obtained via the third-party is based on the description of the item from the media content.

13. The method of claim 9, wherein the candidate item is one of substantially the same as or identical to the item from the media content.

14. The method of claim 9, wherein the media content is at least one of a video content, audio content, and still frame.

15. The method of claim 9, wherein the obtaining includes obtaining data via more than one third-party.

16. The method of claim 9, after the associating, storing the item data obtained by the third-party associated with the candidate item.

17. A method, comprising:
displaying an indicia in association with a video module, the indicia associated with at least one tagged item included in a portion of a media content in the video module;
retrieving data related to each tagged item, the data including a candidate item associated with each tagged item, the retrieving based on actuation of the indicia;
displaying each candidate item associated with each tagged item from the portion of the media content in the video module; and
storing data related to a candidate item when the candidate item is selected in the video module.

18. The method of claim 17, wherein the retrieving includes downloading data from a database.

19. The method of claim 17, wherein the indicia is included in the video module.

20. The method of claim 17, wherein the tagged items from the portion of the media content are tagged items from a currently displayed portion of the media content.

21. The method of claim 17, further comprising:
before the displaying the indicia, streaming the media content from a server.

22. The method of claim 17, wherein the video module includes the indicia and is configured to be embedded as part of a web page.

23. The method of claim 17, wherein when the candidate item selected is purchased, the result includes a compensation to at least one third-party.

24. The method of claim 17, wherein the indicia is a first indicia, the candidate item being selected via actuation of a second indicia in the video module.

25. The method of claim 17, wherein the retrieving includes retrieving data from a database configured to store data related to a candidate item.

26. The method of claim 17, further comprising:
after the storing, sending the data related to the selected candidate item to a third-party such that the candidate item can be purchased via the third-party.

27. The method of claim 17, wherein the displaying each candidate item includes displaying each candidate item associated with each tagged item from the media content.

28. The method of claim 17, wherein the media content is at least one of a video content, audio content, and still frame.

29. A method, comprising:
receiving a request for data from a third-party, the request including data associated with an item from a media content;
sending to the third-party the data including at least one candidate item related to the item from the media content, the third-party configured to associate the at least one candidate item with the item from the media content such that data related to the at least one candidate item is stored by the third-party; and
receiving a purchase request for the candidate item associated with the item from the media content.
